(19) United States
(12) Patent Application Publication
(10) Pub. No.: US 2019/0306206 A1
(43) Pub. Date: Oct. 3, 2019

(54) SYSTEM FOR MANAGING IOT INFORMATION

(71) Applicant: HONGFUJIN PRECISION ELECTRONICS (TIANJIN) CO.,LTD., Tianjin (CN)

(72) Inventor: SHIH-CHENG WANG, New Taipei (TW)

(21) Appl. No.: 15/968,768

(22) Filed: May 2, 2018

(30) Foreign Application Priority Data
Apr. 3, 2018 (CN) 201810291041.9

(51) Int. Cl. H04L 29/06; H04L 12/58; H04L 29/08

(52) U.S. Cl. CPC H04L 65/403; H04L 51/32; H04M 1/0202; H04L 67/12; H04L 51/20

(57) ABSTRACT

A system includes information acquisition apparatus, one or more user terminals and a server communicating with both. The information acquisition apparatus is positioned at a scene for acquired information. The user terminal includes a community establishing module and an inviting module. The community establishing module can be commanded to recognize a social group and set characteristics of the social group. The invitation module can invite other users to join the social group in response to a second user command. The server includes an information analyzing module and an information publishing module. The information analyzing module analyzes the acquired information and determines whether acquired information or part is or is not associated with a characteristic of the social group. The information publishing module can publish to the group acquired information which is determined to be associated with a characteristic of the social group.

### CROSS-REFERENCE TO RELATED APPLICATIONS

This application claims priority to Chinese Patent Application No. 201810291041.9, filed on Apr. 3, 2018, the contents of which are incorporated by reference herein.

### FIELD

The subject matter herein generally relates to internet of things (IOT), and especially relates to an IOT information management system.

### BACKGROUND

IOT systems include information acquisition devices and a monitoring terminal communicating with the information acquisition devices. The information acquisition device acquires information of various scenes and transmits the information to the monitoring terminal. The monitoring terminals are each positioned at their own scene. If a user wants to obtain information, the user needs to reach the specific position or scene or otherwise the information is sent to the user by e-mail.

### BRIEF DESCRIPTION OF THE DRAWINGS

Implementations of the present technology will now be described, by way of example only, with reference to the attached figures.

FIG. 1 is a schematic diagram of a system for managing IOT information.

FIG. 2 is a block diagram of the system in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

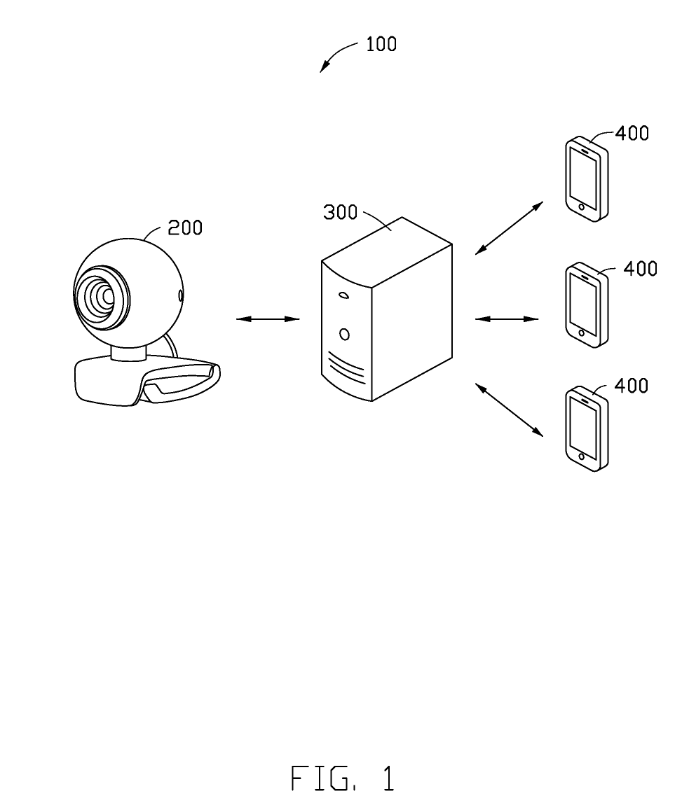

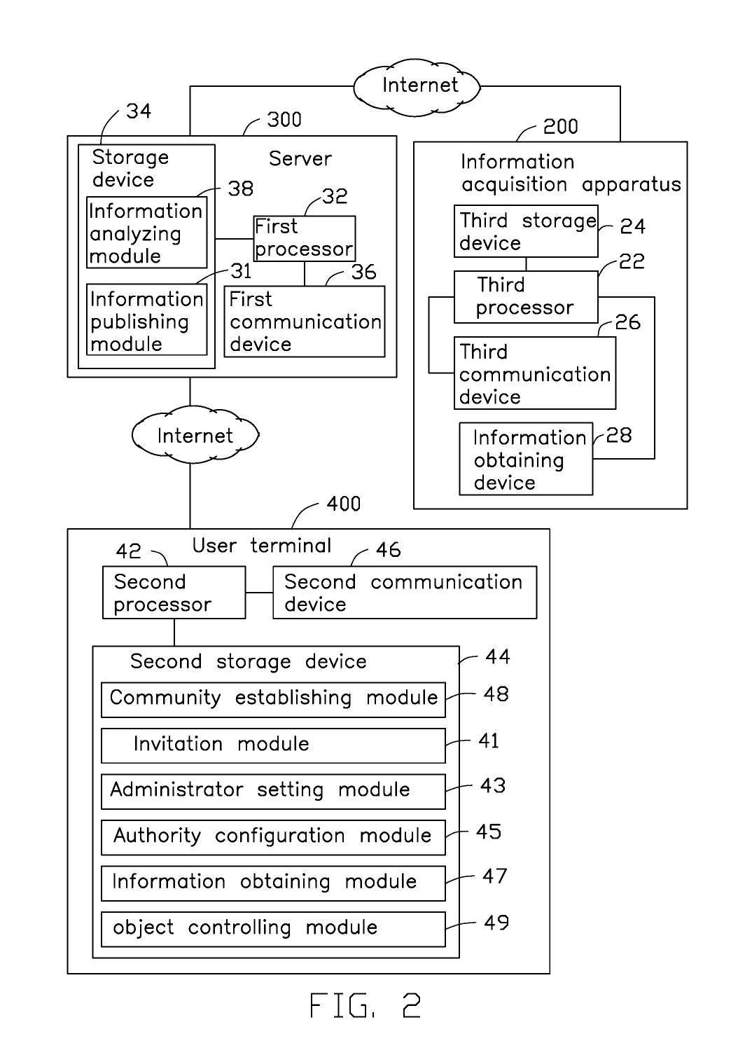

FIGS. 1 and 2 illustrate a system for managing IOT information 100 including at least one information acquisition apparatus 200, a server 300, and a number of user terminals 400. The information acquisition device 200 and the user terminals 400 communicate with the server 300. The at least one information obtaining apparatus 200 is positioned where it can acquire image information of at least one scene and transmit the image information to the server 300. The server 300 is configured to analyze the received image information so that the user can obtain information as to the scene.

The server 300 may include, but is not limited to, at least one first processor 32, a first storage device 34, and a first communication device 36. The at least one first processor 32, the first storage device 34, and the first communication device 36 are electronically connected to each other. The at least one first processor 32 can process data of the server 300. The first storage device 34 stores program codes of the server 300 and data transmitted from information acquisition device 200 and the user terminals 400. The server 300 can communicate with the information acquisition device 200 and the user terminal 400 through the first communication device 36.

The user terminal 400 may include, but is not limited to, at least one second processor 42, a second storage device 44, and a second communication device 46. The at least one second processor 42, the second storage device 44, and the second communication device 46 are electronically connected to each other. The at least one second processor 42 can process data of the user terminal 400. The second storage device 44 stores program codes of the user terminal 400 and the data transmitted from the server 300. The user terminal 400 can communicate with the server 300 through the second communication device 46. The user terminal 400 can be a portable electronic device, such as a mobile phone or a tablet computer.

The information acquisition apparatus 200 may include, but is not limited to, at least one third processor 22, a third storage device 24, and a third communication device 26. The at least one third processor 22, the third storage device 24, and the third communication device 26 are connected to each other. The at least one third processor 22 can process data of the information acquisition apparatus 200. The third storage device 24 stores program codes of the information acquisition apparatus 200. The information acquisition apparatus 200 communicates with the server 300 through the third communication device 26. The information acquisition apparatus 200 includes an information acquisition nodule 28. The information acquisition module 28 acquires information. The information acquisition module 28 can be a camera. The third storage device 24 further stores the acquired information.

The user terminal 400 includes a community establishing module 48 and an invitation module 41. The community establishing module 48 is configured to establish a social group in response to a user operation and to set properties of the social group. The invitation module 41 is configured to invite other users to join the social group in response to a user operation. The server 300 includes an information analyzing module 38 and an information publishing module 31. The information analyzing module 38 is configured to analyze the acquired information and determine whether the acquired information is or can be associated with a characteristic of the social group. The information publishing module 31 is configured to publish to the social group acquired information which is determined to be associated with a characteristic of the social group. The information acquisition module 28 can be a camera. The camera captures images of the scene around it. The information analyzing module 38 analyze the image and determine that the image is associated or is not associated with a characteristic of the social group.

In an embodiment, one characteristic includes a topic published by or for the social group. The information analyzing module 38 is configured to analyze whether content topic of acquired information is consistent with the published topic. The information publishing module 31 publishes relevant acquired information to the social group when the content of acquired information is found to be consistent with the published topic.

In another embodiment, one characteristic can further include a geographic area or region (geoscope). The acquired information includes a geographic location of a scene. The information analyzing module 38 is further configured to analyze whether the geographical position in the acquired information is within the geoscope. When the content is found to be consistent with the published topic and the geographical position in the acquired information is within the geoscope, the information publishing module 31 publishes such information to the social group.

The user terminal 400 further includes an administrator setting module 43, an authority configuration module 45, and an information obtaining module 47. The administrator setting module 43 is configured to select a user within a social group as a primary manager. The authority configuration module 45 is configured to allocate information authority to a user by the primary manager. In an embodiment, a number of users have same information authority. In another embodiment, a number of users have different information authorities. For example, one user has a first information authority and another user has a second information authority. The information obtaining unit 47 receives the acquired information corresponding to the information authority at the user terminal 400 of the user.

In an embodiment, the system 100 is configured to monitor conditions in a geoscope relevant to fire and fire risk. The information acquisition device 200 includes an imaging device and a smoke monitoring device. The published topic and geographical location corresponding to a characteristic of the social group are fire and fire risk conditions and the geoscope. The information acquisition device 200 transmits information about fire and fire risk conditions to the server 300. The acquired information includes geographical location. The acquired information may be text information or video information. The server 300 analyzes the acquired information and publishes such information conforming to the characteristic to the relevant social group.

The geoscope includes at least a first monitoring region and a second monitoring region. The geographical location of the acquired information includes the first monitoring region and the second monitoring region. The characteristic of the social group includes a first characteristic and a second characteristic. The first characteristic is a permission to view acquired information in the first monitoring region, and the second characteristic is a permission to view acquired information in the second monitoring region. The primary manager can allocate a first authority to a first user and allocate a second authority to a second user. According to the first authority of the first user, the information obtaining unit 47 acquires information of the first monitoring region about fire conditions on the user terminal 400 corresponding to the first user. According to the second authority, the information obtaining unit 47 acquires information of the second monitoring region about fire conditions on the user terminal 400 corresponding to the second user. In this way, a user is able to obtain the acquired information about fire conditions corresponding to his authority.

In another embodiment, the user terminal 400 further includes an object controlling module 49. The object controlling module 49 is configured to allow user control of an object after the user obtains the acquired information. In one embodiment, the system 100 is configured to monitor visitors at a building and control an access control device of the building. The information acquisition device 200 acquires a video of a visitor at an entrance of the building. The building includes an electronic door and an access control device at the entrance. The access control device can open or lock the electronic door. The visitor contacts a host by pressing the room number on the access control device. The primary manager may establish a visiting social group and make an owner of a household aware of the visiting social group. The owner of each household may have authority to receive acquired information (that is, video of a visitor) when the visitor presses the room number of the household. After receiving the video of the visitor, the user can then perform an unlocking or opening of the electronic door, using his user terminal 400. The object controlling module 49 transmits an open door signal to the access control device. The access control device opens the electronic door accordingly. In this way, the user can control the opening of the electronic door through his user terminal 400.

The administrator setting unit 43 is further configured to allow the primary manager to set a secondary manager. The administrator setting unit 43 is further configured to allocate to the secondary manager the information authority necessary for the function of the secondary manager.

The exemplary embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A system for managing TOT information comprising:
at least one information acquisition apparatus positioned where it can acquire image information of at least one scene;
at least one user terminal comprising:
a community establishing module configured to establish a social group in response to a first user operation and set characteristics of the social group; and
an invitation module configured to invite other users to join the social group in response to a second user operation;
a server communicating with the at least one information acquisition apparatus and the at least one user terminal and comprising:
an information analyzing module configured to analyze the acquired information and determine whether the acquired information is associated with the characteristic of the social group; and
an information publishing module configured to publish to the social group acquired information which is determined to be associated with a characteristic of the social group.

2. The system as claimed in claim 1, wherein the characteristic comprises a topic published by the social group, the information analyzing module analyzes whether a content topic of the acquired information is consistent with the published topic, the information publishing module publishes relevant acquired information to the social group when the content of the acquired information is found to be consistent with the published topic.

3. The system as claimed in claim 2, wherein the characteristic further comprises a geographic area, the acquired information comprises a geographic location of the scene.

4. The system as claimed in claim 3, wherein, the information analyzing module is further analyzes whether the geographical position in the acquired information is within the geographic area, the information publishing module publishes to the social group the acquired information when the content the acquired information is found to be consistent with the published topic and the geographical position in the acquired information is within the geographic area.

5. The system as claimed in claim 1, wherein the user terminal further comprises:
an administrator setting module configured to select a user within the social group as a primary manager;
an authority configuration module configured to allocate information authority to a user by the primary manager; and
an information obtaining module configured to acquire the acquired information corresponding to the information authority at the user terminal of the user.

6. The system as claimed in claim 5, wherein a plurality of users have a same information authority.

7. The system as claimed in claim 5, wherein a plurality of users have different information authorities.

8. The system as claimed in claim 1, wherein the administrator setting module is further configured to allow the primary manager to set a secondary manager, the administrator setting unit is further configured to allocate to the secondary manager with the information authority necessary for the function of the secondary manager.

9. The system as claimed in claim 1, the user terminal further includes an object controlling module, the object controlling module is configured to allow user control of an object after the user obtains the acquired information.

10. The system as claimed in claim 1, wherein the user terminal is a portable electronic device.

11. A system for managing TOT information comprising:
at least one camera positioned at where it can capture images of at least one scene;
at least one user terminal comprising:
a community establishing module configured to establish a social group in response to a first user operation and set characteristics of the social group; and
an invitation module configured to invite other users to join the social group in response to a second user operation;
a server communicating with the at least one camera and the at least one user terminal and comprising:
an information analyzing module configured to analyze the image and determine whether the image is associated with the characteristic of the social group; and
an information publishing module configured to publish to the social group the image which is determined to be associated with the characteristic of the social group.

12. The system as claimed in claim 11, wherein the characteristic comprises a topic published by the social group, the information analyzing module analyzes whether a content topic of the image is consistent with the publish topic, the information publishing module publishes relevant image to the social group when the content of the image is found to be consistent with the published topic.

13. The system as claimed in claim 12, wherein the characteristic further comprises a geographic area, the information analyzing module is further analyzes whether a geographical position of the image is within the geographic area, the information publishing module publishes to the social group the image when the content of the image is found to be consistent with the published topic and the geographical position of the image is within the to the geographic area.

14. The system as claimed in claim 11, wherein the user terminal further comprises:
an administrator setting module, configured to select a user within the social group as a primary manager;
an authority configuration module configured to allocate information authority to a user by the primary manager; and
an information obtaining module configured to acquire the image corresponding to the information authority at the user terminal of the user.

15. The system as claimed in claim 14, wherein a plurality of users have a same information authority.

16. The system as claimed in claim 14, wherein a plurality of users have different information authorities.

17. The system as claimed in claim 11, wherein the administrator setting module is further configured to allow the primary manager to set a secondary manager, the administrator setting unit is further configured to allocate to the secondary manager with the information authority necessary for the function of the secondary manager.

18. The system as claimed in claim 11, the user terminal further includes an object controlling module, the object controlling module is configured to allow user control of an object after the user obtains the image.

19. The system as claimed in claim 11, wherein the user terminal is a portable electronic device.

20. The system as claimed in claim 19, wherein the portable electronic device is a mobile phone.
